(19) United States
(12) Patent Application Publication
(10) Pub. No.: US 2023/0011081 A1
(43) Pub. Date: Jan. 12, 2023

(54) CELLULOSE COMPOSITE MATERIAL, 3D PRINTING MATERIAL AND 3D PRINTING STRUCTURE INCLUDING THE SAME, AND METHOD OF MANUFACTURING THE 3D PRINTING STRUCTURE USING THE SAME

(71) Applicants: KOREA INSTITUTE OF SCIENCE AND TECHNOLOGY, Seoul (KR); KOREA ADVANCED INSTITUTE OF SCIENCE AND TECHNOLOGY, Daejeon (KR)

(72) Inventors: Myoung-Woon MOON, Seoul (KR); Hyesung CHO, Seoul (KR); Cho-hee LEE, Seoul (KR); Taegeun KIM, Seoul (KR); Haeshin LEE, Daejeon (KR); Younseon WANG, Daejeon (KR); Yunhan LEE, Daejeon (KR)

(73) Assignees: KOREA INSTITUTE OF SCIENCE AND TECHNOLOGY, Seoul (KR); KOREA ADVANCED INSTITUTE OF SCIENCE AND TECHNOLOGY, Daejeon (KR)

(21) Appl. No.: 17/860,673

(22) Filed: Jul. 8, 2022

(30) Foreign Application Priority Data
Jul. 8, 2021 (KR) 10-2021-0089941

(51) Int. Cl. B29C 64/112; C08L 1/02; C08L 5/08; C08L 79/02; C08L 79/08

(52) U.S. Cl. CPC B29C 64/112; C08L 1/02; C08L 5/08; C08L 79/02; C08L 79/08; B33Y 70/00

(57) ABSTRACT

Provided are a cellulose composite material, a three-dimensional (3D) printing material and a 3D printing structure including the cellulose composite material, and a method of manufacturing a 3D printing structure using the cellulose composite material. The cellulose material may be used as a 3D printable eco-friendly material using cellulose that is an eco-friendly natural material and a compound having a catechol group that is derived from nature, and a structure implemented with 3D printing has excellent tensile strength or compressive strength.

### CROSS-REFERENCE TO RELATED APPLICATION

This application is based on and claims priority under 35 U.S.C. § 119 to Korean Patent Application No. 10-2021-0089941, filed on Jul. 8 2021, in the Korean Intellectual Property Office, the disclosure of which is incorporated by reference herein in its entirety.

### BACKGROUND

### 1. Field

One or more embodiments relate to a cellulose composite material, a three-dimensional (3D) printing material and a 3D printing structure including the cellulose composite material, and a method of manufacturing the 3D printing structure using the cellulose composite material. More particularly, one or more embodiments relate to a cellulose composite material using a cellulose material and a natural adhesive agent, an eco-friendly material that may be 3D printed, including the same, and a method of manufacturing a 3D printing structure using the same.

### 2. Description of the Related Art

Recently, the range of use of three-dimensional (3D) printing technology has been expanded from manufacturing of small products to large-scale structure construction, such as large construction, and thus, functionalization or mass production of materials are considered to be very important. Furthermore, the development of processes, in which high functionality (shape memory, high strength, high conductivity, flame retardant, etc.) materials can be printed, is required, and the development of new materials having desired functionality by mixing eco-friendly materials, such as biodegradable materials, or biomaterials, such as cells, has been attempted, but printing research on composite materials and functional materials is further required more and more.

In 3D printing technology, material technology is a very important portion but thermal, mechanical durability and environmental harmfulness of materials are suggested. Various materials are being developed according to 3D printing methods, but most of them are limited to materials such as metal materials and engineering plastics to improve strength. In 3D printing materials, there are inadequate cases of discovering and utilizing traditional materials from nature except for some materials, and the utilization of 3D printing materials is not widespread. In particular, design of cement-based materials required for implementation of cement-based 3D printing as construction materials and research on 3D printing systems are under progress and used for construction using soil or wood, but systematic data for technical data is not prepared.

There have been a lot of research that enables 3D printing for various materials and analyzes the physical properties of the printed structure. In order to manufacture 3D printing materials using wood materials, 3D printing materials containing some wood materials by manufacturing a filament containing 20% to 30% of wood-fiber based on plastic have been developed. However, because 3D printing materials are manufactured based on thermoplastic plastics, the 3D printing materials need to be extruded at a temperature of 200° C. or higher, which causes thermal degradation of wood-fiber and leads to degradation of physical properties. In addition, an interface between wood-fiber and plastic and an interface between printing layers are unstable, and mechanical physical properties are different in a structure size depending on a printing direction. Therefore, it is difficult to use 3D printing materials as structure materials to apply the 3D printing materials to design and interpretation due to non-uniform strength.

### SUMMARY

One or more embodiments include a cellulose composite material that may be used as an eco-friendly material that may be three-dimensional (3D) printed.

One or more embodiments include a 3D printing material that is eco-friendly and has improved physical properties based on the cellulose composite material.

One or more embodiments include a method of manufacturing a 3D printing structure using the 3D printing material.

Additional aspects will be set forth in part in the description which follows and, in part, will be apparent from the description, or may be learned by practice of the presented embodiments of the disclosure.

According to one or more embodiments, a cellulose composite material includes a cellulose material, a compound having a catechol group, and an amine polymer.

The cellulose material may include micro cellulose, nanocellulose, cellulose nanocrystals, or a combination thereof.

The cellulose material may have a shape of particles, powder, fiber, sponge, or a combination thereof.

The cellulose material may include nanocellulose particles having a size of a length of 10 to 20 nm and a width of 2 to 5 nm.

The cellulose material may have a shape of powder with a particle diameter of 1 μm to 400 μm.

The compound having a catechol group may include at least one of catechol molecules and catechol derivative molecules.

The compound having a catechol group may include at least one or more selected from the group consisting of 1,2-dihydroxybenzene, dopamine, polydopamine, pyrogallol, alpha-methyl dopamine, norepinephrine, dihydroxyphenylalanine, alpha-methyldopa, droxidopa, 5-hydroximin, chitosan-catechol, hyaluronic acid-catechol, and alginate-catechol.

The amine polymer may include at least one or more selected from the group consisting of chitosan, poly(allylamine), poly(L-lysine), and polyethyleneimine.

The cellulose fiber, the compound having a catechol group, and the amine polymer may be bonded to each other and combined by physical binding, chemical binding, or combination thereof.

The content of the compound having a catechol group may be, based on 100 parts by weight of the cellulose fiber, 1 to 30 parts by weight, and the content of the amine polymer may be 10 to 70 parts by weight based on 100 parts by weight of the cellulose fiber.

According to one or more embodiments, there is provided a three-dimensional (3D) printing material including the cellulose composite material.

According to one or more embodiments, the 3D printing material may further include a solvent which may include water, ethyl alcohol, methyl alcohol, glycerol, propylene glycol, isopropyl alcohol, isobutyl alcohol, polyvinyl alcohol, cyclohexanol, octyl alcohol, decanol, hexadecanol, ethylene glycol, 1.2-octaindiol, 1,2-dodecaindiol, 1,2-hexadecaindiol, and a mixture thereof.

According to one or more embodiments, there is provided a 3D printing structure including the cellulose composite material.

The infill density of the 3D printing structure may range from 30% to 100%.

The internal structure of the 3D printing structure may have a zigzag shape, a cross shape, a grid shape, a concentric shape, or a combination shape thereof.

According to one or more embodiments, a method of manufacturing a 3D printing structure includes discharging the 3D printing material through a spray nozzle of a 3D printer to form an output material, and drying and oxidizing the output material.

The 3D printer may use a screw extrusion method.

The drying may be performed at temperature of 20° C. to 70° C. and under humidity of 50% to 100%.

The drying may be performed under constant temperature and constant humidity conditions.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a schematic diagram of a cellulose composite material according to an embodiment, and FIG. 1B shows a scan electron microscope image of the cellulose composite material;

FIG. 2 shows an image of a design diagram for three-dimensional (3D) printing output, a printing process, and a process of manufacturing a cellulose output structure through oxidation according to Example 1;

FIG. 3 shows images of output materials of the cellulose composite material manufactured by using a mold and a 3D printer according to Example 1, which are optical photo images showing changes in color and outer surface roughness immediately after sample manufacturing and after sample drying and oxidation, respectively;

FIG. 4A shows a three-point flexural experiment of the 3D printing output material manufactured of the cellulose composite material according to Example 1, and FIG. 4B is a graph showing the result of a three-point flexural strength experiment;

FIG. 5 illustrates 3D printing output materials manufactured by fixing a 3D printing infill path in a zigzag form using the cellulose composite material and by changing infill into 40%, 70%, 90%, and 100% according to Example 2;

FIG. 6 shows a strain-stress graph and typical fracture surfaces according to each infill density according to Example 2, that is, FIG. 6A shows a compressive strength-strain graph of an output material according to four infill densities, FIG. 6B shows a compressive strength comparison graph, and FIG. 6C shows an image of infill 70% (above), infill 90% (center), and infill 100% (below) as images of a fracture surface after compressive strength evaluation;

FIG. 7 shows the design of 3D printing according to Example 3 and the result thereof, (a) shows the designs of 3D printing according to each infill shape in Example 3, (b) shows the structures just before drying, and (c) shows structures after drying;

FIG. 8A shows a compressive strength-strain graph of a 3D printing structure according to an infill shape according to Example 3, and FIG. 8B shows a graph of comparing a maximum compressive strength value according to an infill shape with a compressive strength value of a mud-plastered wall, wood (softwood, hardwood), and a wood grain, MDF, and a cellulose molding sample.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein.

Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The present inventive concept, which is described below, can be modified in various forms and may have various embodiments. Thus, specific embodiments will be illustrated in the drawings and will be described in detail in the detailed description. However, the present inventive concept is not limited to specific embodiments, and it will be understood that the present inventive concept includes all modifications, equivalents, or substitutes included in the technical scope of the present inventive concept.

The terms used herein are used to describe only specific embodiments and are not intended to limit the present inventive concept. The singular expression includes a plurality of expressions unless the context is clearly different. In the present specification, the terms such as “comprising” or “having” are meant to be the features described in the specification, the steps, the operations, the components, the parts, the elements, materials, or a combination thereof are present, and the presence or possibility of one or more other features, numbers, steps, operations, components, parts, elements, materials, or a combination thereof will be added, is not excluded in advance.

In the drawings, the thickness is enlarged or reduced to clearly express several layers and areas. Through the specification, the same drawing number is attached to similar parts. In the present specification, when a portion such as a layer, a film, a region, a plate or the like is “on” or “above” another portion, this is not only when the portion is directly on another portion but also when another portion is interposed therebetween. In the present specification, the terms of the first and second, etc. may be used to describe various components, but these components should not be limited to the terms. The terms are used only for the purpose of distinguishing one component from other components.

Although the terms such as the first and second, may be used to describe various elements, components, areas, layers and/or regions, these elements, components, areas, layers, and/or regions should not be limited to the terms.

In addition, the process described in the present disclosure does not necessarily mean that it is applied in order. For example, when the first and second steps are described, it can be understood that the first step should be performed before the second step.

Hereinafter, a cellulose composite material, a three-dimensional (3D) printing material and a 3D printing structure including the same, and a method of manufacturing a 3D printing structure using the same will be described in detail.

The cellulose composite material according to an embodiment includes a cellulose material; a compound having a catechol group; and an amine polymer.

The cellulose composite material according to one embodiment is based on cellulose materials, and may be prepared by mixing the cellulose materials with an adhesive agent for increasing a binding force between the cellulose materials. A compound including a catechol group, which is a natural adhesive ingredient, and an amine polymer are used as the adhesive agent.

The present inventors confirmed that when 3D printing is performed using the cellulose composite material, existing glass, cement-based materials, or harmful ingredient additives may be excluded, and thus, this is eco-friendly and a more stable structure than a 3D printing structure made of a wood material manufactured according to the related art may be formed.

In the cellulose composite material according to one embodiment, cellulose materials are used as a main skeletal structure. Cellulose is a strong fibrous polysaccharide connected by combination of beta-glucoside, which may be obtained mainly through perennial plants such as wood and bamboo, with year-long pool and bacteria.

The cellulose materials may include microcrystalline cellulose, nanocrystalline cellulose, or a combination thereof. The cellulose materials may have various shapes of particles, powder, fiber, and sponge, or a combination thereof based on microcrystal cellulose and nanocrystal cellulose. Cellulose powder has features of controlling functionality, such as purity or size, hydrophilicity, and hydrophobicity.

According to an embodiment, the cellulose materials may be micro cellulose having a micro-scale powder shape. The cellulose materials may have a powder shape with a particle diameter of 1 μm to 400 μm, for example, and may have a hydrophilic surface. The powder form in the range of the particle diameter range is easy to be discharged through a nozzle of a 3D printer for performing 3D printing, which may allow 3D printing. Micro cellulose may be extracted and used from wood or bamboo, which is one of the important building materials.

According to an embodiment, the cellulose materials may include cellulose microfibers, and the cellulose microfibers may include cellulose nanofibers or cellulose nanocrystals. The cellulose nanofibers or cellulose nanocrystals may have sizes, that is, a length of 10 nm to 20 nm and a width of 2 to 5 nm, for example. The density of the cellulose materials including cellulose nanofibers may be 0.3 to 1.0 g/cm³, and specifically, for example, about 0.6 g/cm³. Because cellulose nanofibers use natural polymer cellulose as raw materials, they basically have reproduceable characteristics, biodegradability, and biocompatibility and may achieve high mechanical strength and elastic coefficients through miniaturization of fibers. In addition, cellulose nanofibers have a high specific surface area and a high aspect ratio to express desired functions through surface modification and mixing with other functional materials.

According to an embodiment, the cellulose materials may include micro cellulose, nanocellulose, cellulose nanocrystals, or a combination thereof.

The cellulose composite material may include a compound having a catechol group, and amine polymer as adhesive ingredients.

By applying a compound having a catechol group and an amine polymer as adhesive ingredients, a strong adhesive force may be formed between cellulose materials through oxidative crosslinking reactions by oxygen in the air. In general, an amine polymer is known to have an excellent adhesive force with cellulose ingredients, like being used in pulp separation, and in embodiments of the present disclosure, additional chemical binding by oxidative crosslinking reactions by catechol-based compounds caused by oxygen in the air is formed so that powerful adhesion between cellulose materials may be formed.

Because the compound having a catechol group has a high bonding force, the compound may serve as a binding agent for binding materials contained in the cellulose composite material and the 3D printing material. By using the compound having a catechol group, 3D printing resulting materials having good quality with a high tensile strength to a high compressive strength may be obtained.

The term “compound having a catechol group” used herein means that the compound may include at least one of catechol molecules and catechol derivative molecules. Catechol molecules are also known as 1,2-hydroxybenzene or pyrocatechol, and catechol derivatives are molecules including a benzene ring and at least two hydroxy groups bonded to the benzene ring. Catechol derivatives having an adhesive force that may be used in the cellulose composite material may include, for example, dopamine, polydopamine, pyrogallol, alpha-methyl dopamine, norepinephrine, dihydroxyphenylalanine, alpha-methyldopa, droxidopa, 5-hydroximin, deacetylation chitosan-catechol, hyaluronic acid-catechol, and alginate-catechol. More specifically, the catechol derivatives may include one or more of pyrogallol, polydopamine, deacetylation chitosan catechol, hyaluronic acid catechol, and alginate catechol, but embodiments are not limited thereto. Polydopamine or chitosan catechol is a material that is synthesized in mussels, exhibits almost all surface excellent bonding force regardless of the specificity of the surface, and may be useful because it is known that the bonding force persists in water.

The term “amine polymer” used herein means that this polymer is a polymer formed from a monomer with an amine group, and may include one or more selected from the group consisting of, for example chitosan, poly allylamine, poly(L-lysine), and polyethyleneimine.

In the present specification, the ‘adhesive ingredients’ may be used by being mixed with the ‘adhesive agent’.

The cellulose composite material may be bonded and combined by physical binding and chemical binding of the cellulose fiber, the compound having a catechol group, and the amine polymer, or a combination thereof.

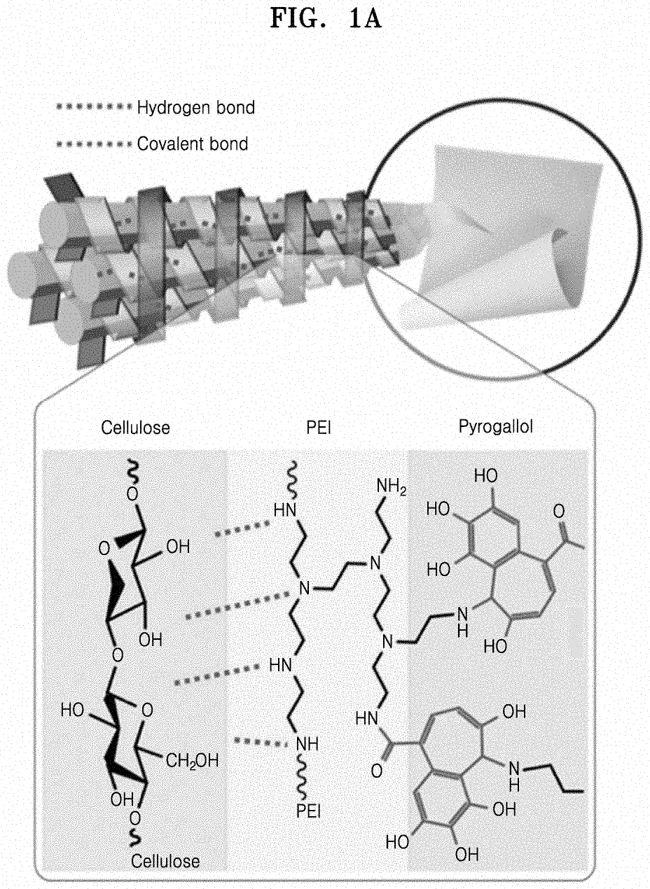

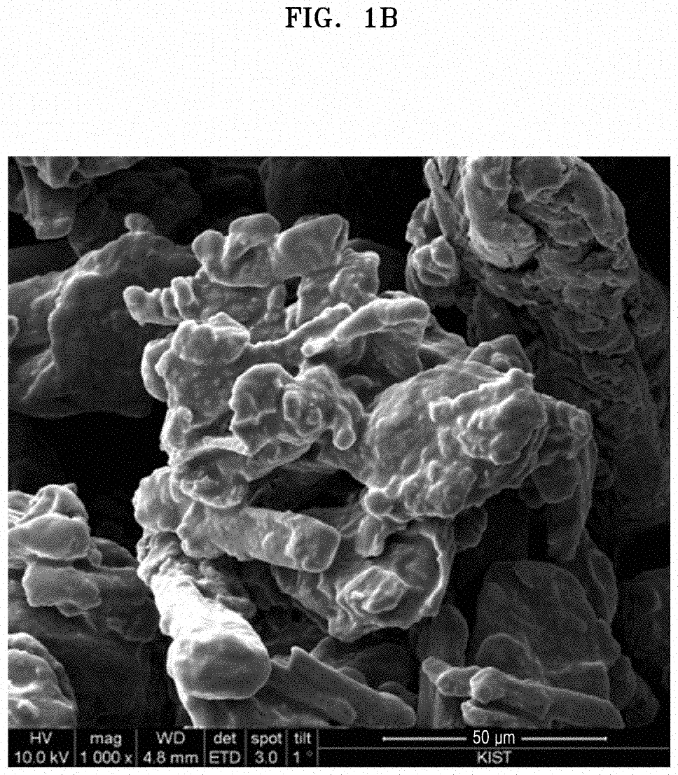

FIG. 1A is a schematic diagram of a cellulose composite material according to an embodiment, and FIG. 1B shows a scan electron microscope image of the cellulose composite material.

As shown in FIGS. 1A and 1B, a cellulose material constituting the cellulose composite material may include cellulose nanofibers, and may have a state in which the cellulose material, a compound having a catechol group (e.g., pyrogallol), and an amine polymer (e.g., PEI) are physically or chemically bonded to each other and combined. The cellulose composite material may be applied as a 3D printing material by a high (strong) binding force between the compound having a catechol group and the amine polymer to form a stable 3D structure.

According to one embodiment, the content of the compound having a catechol group may be 1 to 30 parts by weight, and the content of the amine polymer may be 10 to 70 parts by weight based on 100 parts by weight of the cellulose fiber. Specifically, for example, the content of the compound having a catechol group may be 3 to 15 parts by weight, and the content of the amine polymer may be 20 to 50 parts by weight based on 100 parts by weight of the cellulose fiber. A cellulose composite material having excellent physical properties in the content range may be obtained.

According to another embodiment, a 3D printing material containing the above-described cellulose composite material may be provided.

In the 3D printing material, the cellulose material has the advantage of excluding existing cement-based materials or harmful ingredients, and may be combined through an adhesive agent of natural ingredients to manufacture a stable 3D structure. Therefore, the cellulose composite material has a configuration and characteristic suitable for 3D printing, and may easily manufacture a high-quality 3D structure through 3D printing.

In the manufacture of the 3D printing material, the cellulose material and the compound having a catechol group, which are adhesive ingredients, and an amine polymer may be uniformly mixed with each other using a solvent. Because the 3D printing material contains a compound having a catechol group, when printing is performed using a water-soluble solvent, a printing factor may be adjusted so that the inner space may be properly adjusted and thus the reaction area with the air is adjusted and an adhesive force between printing layers may be improved. The available solvents may be water and an alcohol solvent. The alcohol solvent may include, for example, ethyl alcohol, methyl alcohol, glycerol, propylene glycol, isopropyl alcohol, isobutyl alcohol, polyvinyl alcohol, cyclohexanotylalchol, decanol, hexadecanol, ethylene glycol, 1.2-octaindiol, 1,2-dodecaindiol, 1,2-hexadecaindiol, and a mixture thereof, and embodiments are not limited thereto.

The 3D printing structure according to one embodiment includes the above-described cellulose composite material. The 3D printing structure may be easily formed through 3D printing using the above-described cellulose composite material.

In order to absorb shock and increase strength, not only the material but also the internal structure of the 3D printing structure is very important. For example, a structure that is capable of distributing shock and may be able to absorb shock, such as a honeycomb structure in nature, a spider web structure, a nacre structure structure, a truss structure, an arched structure, and a dome structure used for the manufacture of bridges, may be used. In particular, when using the 3D printing material, various three-dimensional structures may be implemented, and the infill structure may be changed to maximize the mechanical properties of the entire structure.

According to one embodiment, infill of the 3D printing structure may range from 30% to 100%. The 3D printing structure may maximize the oxidation of the adhesive agent by changing infill conditions, and may be printed into a structure having optimal mechanical physical properties under the infill conditions in the range.

The 3D printing structure may have various internal structures and may adjust a printing factor to properly design the inner space so that the reaction area with the air may be adjusted and thus an adhesive force between printing layers may be improved. The internal structure of the 3D printing structure, for example, may have a zigzag shape, a cross shape, a grid shape, a concentric shape, or a combination shape thereof, and embodiments are not limited thereto.

A method of manufacturing a 3D printing structure, according to an embodiment, may include:

discharging the 3D printing material through a spray nozzle of a 3D printer to form an output material; and

drying and oxidizing the output material.

The 3D printer used for 3D printing may use a screw extrusion method. The 3D printer may control the rotation speed and the extrusion of the screws per hour by using the screw extrusion method, and may adjust the moving speed of a nozzle and a distance between layers so that the amount of the cellulose material output to one layer may be adjusted.

The discharged output material may be oxidized while being dried. The output material immediately after being discharged may be yellow or bright, but the final color of the output material may be changed into black through oxidation while being dried. The drying operation may be performed, for example, at a temperature of 20° C. to 70° C. and a humidity of 50% to 100%. Specifically, for example, the drying operation may be performed at a temperature of 30° C. to 70° C. and under a humidity of 70% to 100%. By adjusting the drying speed in the above range, the strength of the output structure may be increased by increasing the degree of hardening. Optimized speed may be secured by comparing cracks of dried output materials and crack types.

The drying operation may be performed under constant temperature and constant humidity conditions. According to one embodiment, the constant temperature and constant humidity chamber may be maintained at a temperature of 70° C. and a humidity of 100%, and may be sufficiently dried at room temperature after 48-hour oxidation so that a 3D structure having high strength may be obtained.

The 3D printing structure may change an infill density, thereby adjusting the mechanical physical properties of the structure after printing. According to an embodiment, the infill of the 3D printing structure may be in a range of 30% to 100%. In the above range, the oxidation of the adhesive agent may be maximized and printed with a structure having optimal mechanical physical properties.

In addition, the shape of the 3D printing structure among infill conditions of the 3D printing structure may be changed so that the mechanical stability of the 3D printing structure may be adjusted. According to one embodiment, the type of infills may be selected from four patterns, such as a cross pattern, a grid pattern, a zigzag pattern, and a concentric pattern, and a combination pattern thereof may also be possible.

Exemplary embodiments will be described in more detail through the following examples and comparative examples. However, examples and comparative examples are intended to illustrate technical ideas, and the scope of the present invention is not limited thereto.

### Example 1

In the present embodiment, an experiment was performed using a composite material made by mixing a cellulose material, an adhesive agent and water at an appropriate ratio as a 3D printing material.

In order to perform 3D printing, lab-level material extrusion (ME) printing equipment was used, cellulose powder, which was smaller than a nozzle diameter, was used, and the particle size of the cellulose powder was maintained at 50-400 micrometers. The main skeletal body of 3D printing materials was powder-type cellulose (Sigma-Alrich, C6288), andan adhesive agent was a polyethyleneimine (PEI) solution (Sigma-Alrich, P3143, 50 wt %), and pyrogallol (P0381, Sigma-Alrich).

In order to uniformly disperse PEI, which is a high viscosity solution, the cellulose powder was mixed with a diluted PEI solution at 10%, and then dried with a lyophilizer to completely remove moisture and to be powdered. As a result of measuring the weight of the completely dried mixture, the average weight was identified as 0. 9 g of PEI per 3 g of cellulose. Through this process, the amount of cellulose in the mixture and the amount of PEI were fixed, and the content of the remaining configuration materials (D.I water and pyrogallol) was adjusted to manufacture 3D printing materials and printed using the same.

The printer used for 3D printing outputted a sample using Cerambot Pro (Cerambot, China) of a screw extrusion method. In order to increase the bonding force between the sample and the floor, a linen with a 10% PEI was attached to a printing bed so that the output of the 3D printing material was performed.

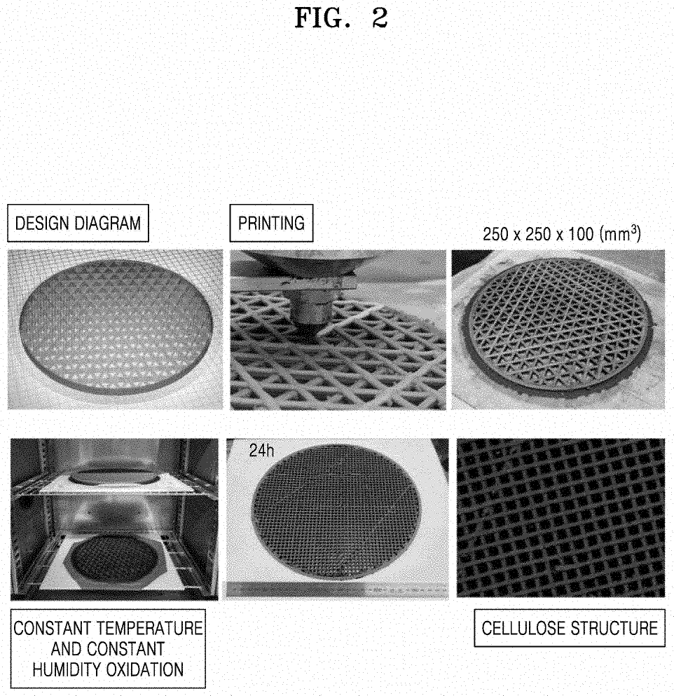

As shown in FIG. 2, the design of the output material was input to the 3D printer, a nozzle size and a distance between the bed and the nozzle was adjusted before the outputting of a three-dimensional shape (Nozzle size 1. 5 mm, distance between the nozzle and the bed 1.4 mm), and in order to adjust the flatness of a bed surface, the 3D printing material was outputted in a flat shape (2D), and basic output conditions were optimized.

In the printer used for 3D printing, the rotation speed of a screw was set to a minimum value by using the screw extrusion method and the amount of extrusion per hour was fixed and then, the moving speed of the nozzle and a distance between layers were adjusted to adjust the amount of cellulose to be outputted to one layer.

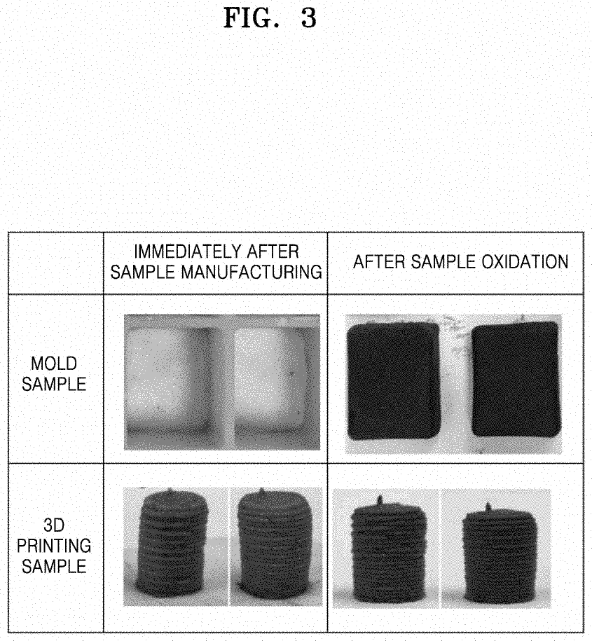

The results of performing oxidation by drying samples made using a mold using a constant temperature and constant humidity chamber and the output materials made using a 3D printer are shown in FIG. 3. As shown in FIG. 3, the samples made were initially yellow or bright, but because of the drying in a constant temperature and constant humidity chamber, the final color changed to black. In addition to the contact area with the air through the maintenance of humidity in a constant temperature and constant humidity chamber, the strength of the structure that was printed by increasing the degree of hardening was increased by adjusting the drying speed. An optimized speed was secured by comparing cracks of dried output materials and crack types. The temperature in the constant temperature and constant humidity chamber was maintained at 70° C. and the humidity was 100%, the humidity and temperature were lowered step by step, and after 48 hours of oxidation, drying was sufficiently performed at room temperature.

### Example 2

By changing the infill density of a 3D printing structure using the cellulose composite material prepared in Example 1, the mechanical physical properties of the structure were adjusted after printing. The infill density was designed and printed in 40%, 70%, 90%, and 100%, and the compressive strength was evaluated.

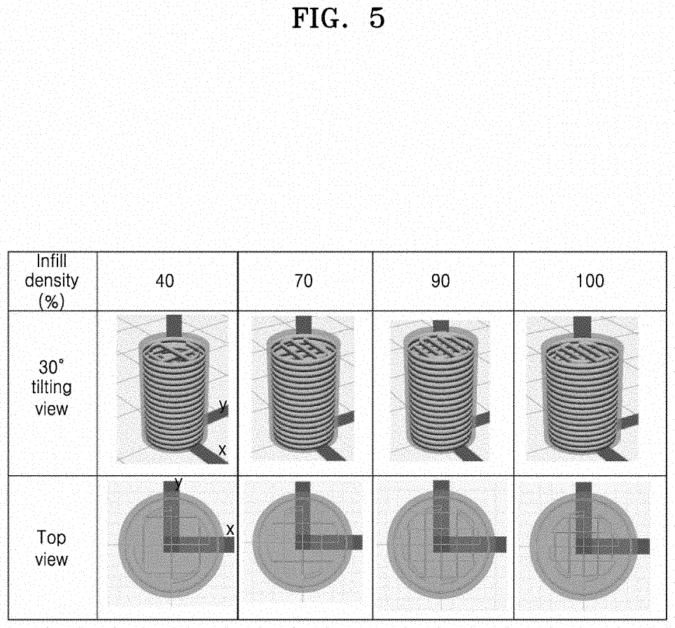

As shown in FIG. 5, a 3D printing infill path was fixed in a zigzag form by using the cellulose composite material manufactured in Example 1, and printing was performed by changing the infill to 40%, 70%, 90%, and 100%. Printing was completed for each condition, and drying and oxidation was performed in the constant temperature and constant humidity chamber. After 48 hours, a printing structure of which oxidation has been completed was obtained.

### Example 3

By changing the shape of infill density conditions of a 3D printing structure using the cellulose composite material prepared in Example 1, the mechanical physical properties of the structure were adjusted.

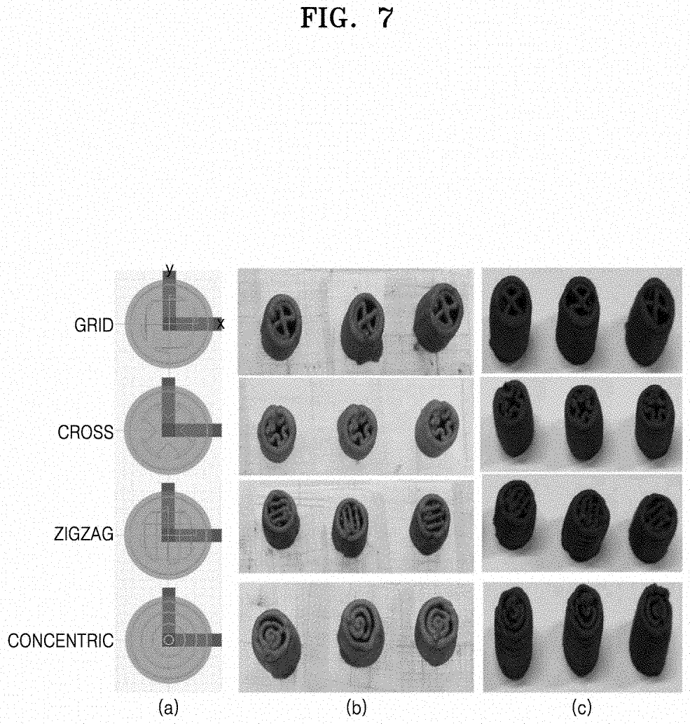

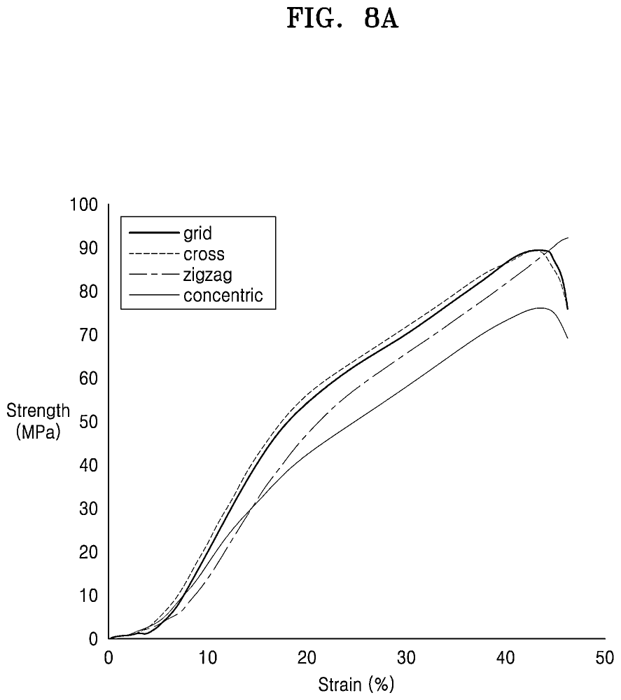

To this end, as shown in FIG. 7, structures were formed by applying four patterns, such as a cross pattern, a grid pattern, a zigzag pattern, and a concentric pattern, to the infill type and then, the compressive strength evaluation of each structure was performed.

In FIG. 7, (a) shows a 3D printing design according to each infill shapes, (b) shows the structures just before drying, and (c) shows structures after drying.

### Evaluation Example 1

A three-point flexural experiment was conducted to analyze the mechanical physical properties of the output structure using the cellulose composite material prepared in Example 1.

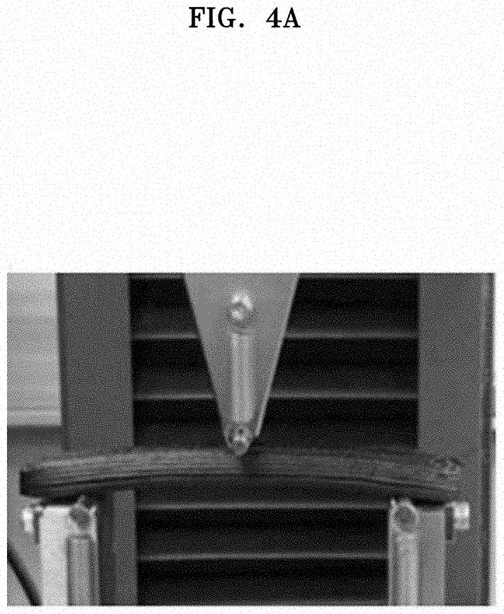

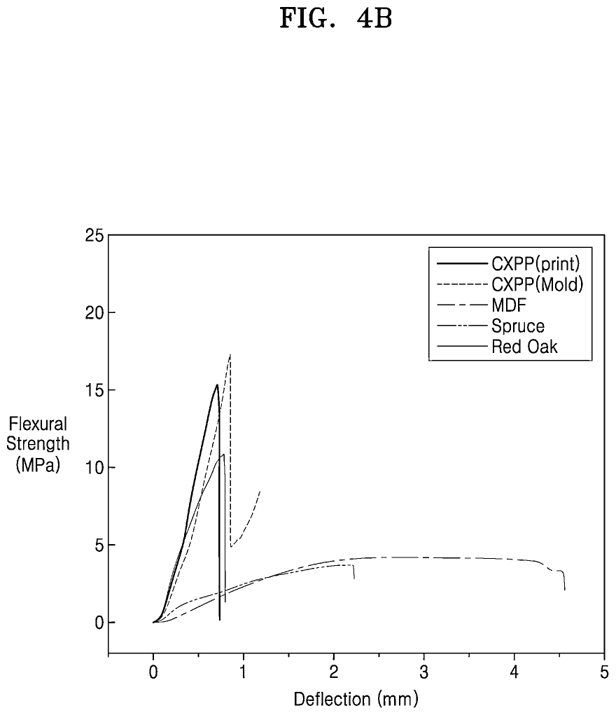

A specimen of 8 mm thickness, 10 mm width, and 30 to 110 mm length was prepared using the cellulose composite material, a three-point flexural experiment was conducted as shown in FIG. 4A, experiments were conducted by measuring using a 5 kN load cell and a speed set to 5 mm/min, when the size of the specimen exceeded 100 mm, a span was set to 80 mm, and when the size of the specimen was less than 100 mm, the span was set to 10 mm. The results of the three-point flexural experiment are shown in FIG. 4B.

As shown in FIG. 4B, a structure (represented by CXPP(print)) output using the cellulose composite material prepared in Example 1 has a flexural strength of 17 MPa on average, and a sample (represented by CXPP(mold)) made of a mold using a cellulose composite material has a flexural strength of about 17.5 MPa. The structure made by 3D printing is known to have rather lower mechanical physical properties than a raw material due to pores and layer adhesion problems that are inevitably generated during the production process.

The structure output using the cellulose composite material manufactured in Example 1 has a very high flexural strength, compared to the case of MDF (flexural Strength: 8.48 MPa) made in a similar manner using wood powder and an adhesive agent.

For reference, the flexural strength results of wood, such as spruce and red oak, are shown in FIG. 4B. In the case of wood, there are very different mechanical physical properties depending on the arrangement direction of the fiber. When the direction of the force acts parallel to the fibrous arrangement direction, wood is easily destroyed and difficult to be used as a building material. The physical properties of extrusion method 3D printing are also expected to change depending on printing directions.

### Evaluation Example 2

The compressive strength evaluation was conducted according to an infill density of the 3D printing structure manufactured in Example 2. The experiment was conducted using a 5 kN load cell for measurement and a speed to 5 mm/min, and when the length of the specimen exceeded 100 mm, the span was set to 80 mm, and when the length of the specimen was less than 100 mm, the span was set to 10 mm.

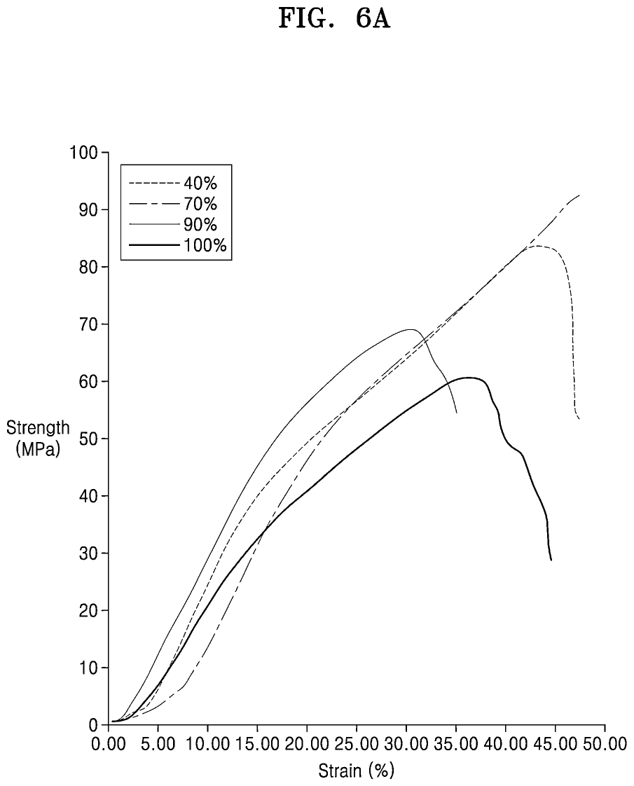

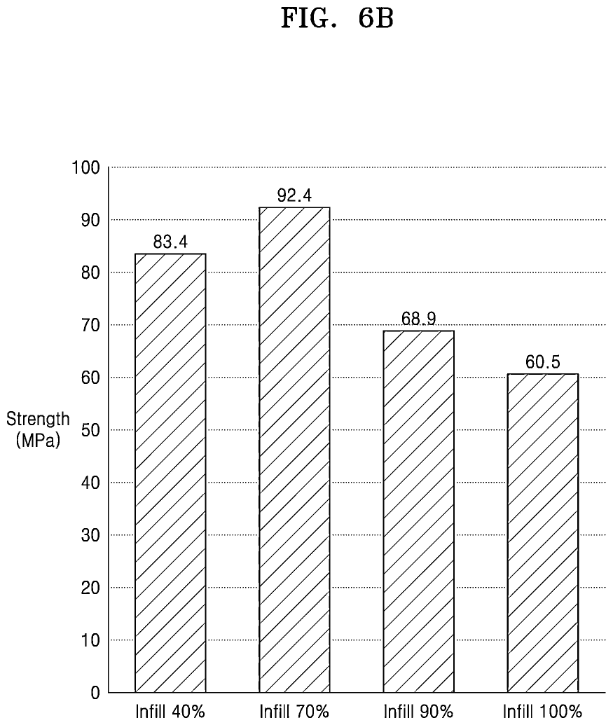

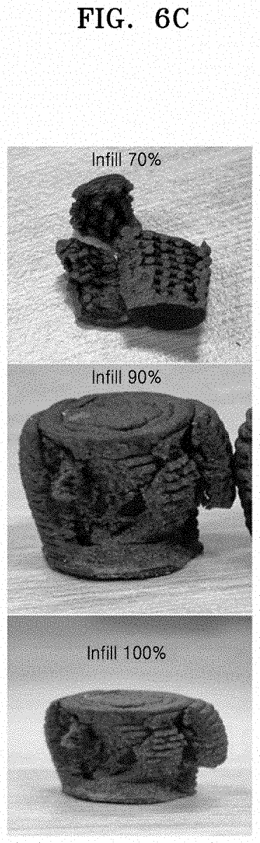

FIGS. 6A and 6B show the result of comparing strain-stress graphs according to the degree of each infill density. FIG. 6A shows a compressive strength-strain rate graph of the output according to four infill densities, and FIG. 6B shows a maximum compressive graph. As shown in FIGS. 6A and 6B, when an infill density is 90%, maximum strength is 92 MPa, and in this case, maximum strain is 25%.

FIG. 6C shows an image of a fracture surface of a 3D printing structure after compressive strength evaluation, (above) 70% infill, (center) 90% infill, and (below) 100% infill of images. As shown in FIG. 6C, analyzing the fracture surface of a high-intensity structure, it shows that when an infill density is 100% high, the interior is maintained brown and hardening is not completely performed. It was found that an infill density was appropriately penetrated from about 90% to the inside, and oxidation was promoted and the color inside the structure was changed to black. In other words, sufficient oxidation progressed, and the hardening of the material was smoothly performed interior.

### Evaluation Example 3

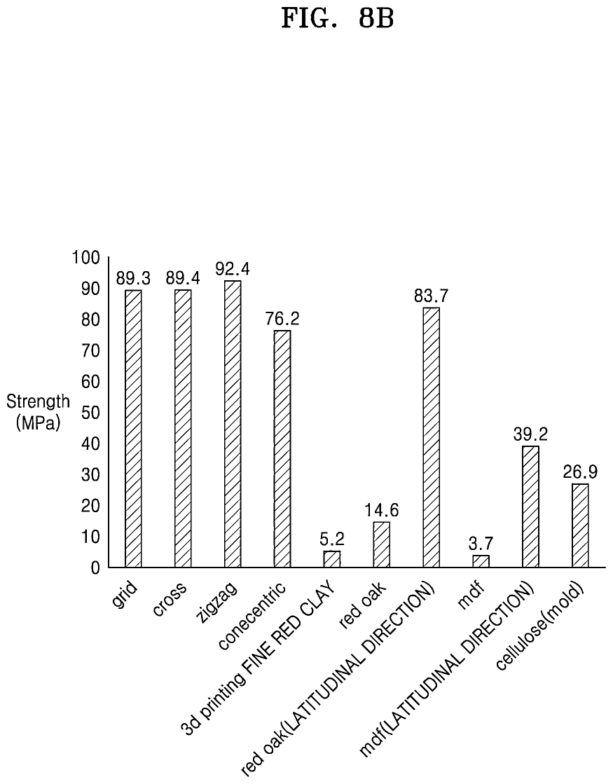

The compressive strength evaluation according to the change of shape in the infill conditions of the 3D printing structure manufactured in Example 3 was performed in the same way as the Evaluation Example 2, and the results are shown in FIGS. 8A and 8B.

FIG. 8B shows compressive strength values of a variety of materials, such as soil walls, wood (softwood, hardwood), wood texture, MDF, and a cellulose molding sample for comparison.

As shown in FIGS. 8A and 8B, 92 MPa was the highest compressive strength of the output structure having a zigzag 70% filling structure in an infill shape, which is much higher than other comparative materials.

The cellulose composite material according to one embodiment can be used as a 3D printable eco-friendly material using cellulose that is an eco-friendly natural material and a compound having a catechol group that is derived from nature, and a structure implemented with 3D printing has excellent tensile strength or compressive strength.

The cellulose composite material is very likely to be applied to new applications (e.g., the human body, automobiles, medicine, fashion, aviation/space, architecture, consumer appliances, entertainment, etc.), as well as effective creation of the functional material market for 3D printers.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A cellulose composite material comprising:
a cellulose material;
a compound having a catechol group; and
an amine polymer.

2. The cellulose composite material of claim 1, wherein the cellulose material comprises micro cellulose, nanocellulose, cellulose nanocrystals, or a combination thereof.

3. The cellulose composite material of claim 1, wherein the cellulose material has a shape of particles, powder, fiber, sponge, or a combination thereof.

4. The cellulose composite material of claim 1, wherein the cellulose material comprises nanocellulose particles having a size of a length of 10 to 20 nm and a width of 2 to 5 nm.

5. The cellulose composite material of claim 4, wherein the cellulose material has a shape of powder with a particle diameter of 1 μm to 400 μm.

6. The cellulose composite material of claim 1, wherein the compound having a catechol group comprises at least one of catechol molecules and catechol derivative molecules.

7. The cellulose composite material of claim 1, wherein the compound having a catechol group comprises one or more selected from the group consisting of 1,2-dihydroxybenzene, dopamine, polydopamine, pyrogallol, alpha-methyldopa, norepinephrine, dihydroxyphenylalanine, alpha-methyldopa, droxidopa, 5-hydroximin, chitosan-catechol, hyaluronic acid-catechol, and alginate-catechol.

8. The cellulose composite material of claim 1, wherein the amine polymer comprises at least one or more selected from the group consisting of chitosan, poly(allylamine), poly(L-lysine), and polyethyleneimine.

9. The cellulose composite material of claim 1, wherein a cellulose fiber, the compound having a catechol group, and the amine polymer are bonded to each other and combined by physical binding, chemical binding, or combination thereof.

10. The cellulose composite material of claim 1, wherein, based on 100 parts by weight of a cellulose fiber, a content of the compound having a catechol group is 1 to 30 parts by weight, and a content of the amine polymer is 10 to 70 parts by weight.

11. A three-dimensional (3D) printing material comprising the cellulose composite material of claim 1.

12. The 3D printing material of claim 11, further comprising a solvent.

13. The 3D printing material of claim 11, wherein the solvent comprises water, ethyl alcohol, methyl alcohol, glycerol, propylene glycol, isopropyl alcohol, isobutyl alcohol, polyvinyl alcohol, cyclohexanol, octyl alcohol, decanol, hexadecanol, ethylene glycol, 1.2-octaindiol, 1,2-dodecaindiol, 1,2-hexadecaindiol, and a mixture thereof.

14. A three-dimensional (3D) printing structure comprising the cellulose composite material of claim 1.

15. The 3D printing structure of claim 14, wherein an infill density of the 3D printing structure is in a range of 30% to 100%.

16. The 3D printing structure of claim 14, wherein an internal structure of the 3D printing structure has a zigzag shape, a cross shape, a grid shape, a concentric shape, or a combination shape thereof.

17. A method of manufacturing a three-dimensional (3D) printing structure, the method comprising:
discharging the 3D printing material of claim 11 through a spray nozzle of a 3D printer to form an output material; and
drying and oxidizing the output material.

18. The method of claim 17, wherein the 3D printer uses a screw extrusion method.

19. The method of claim 17, wherein the drying is performed at temperature of 20° C. to 70° C. and under humidity of 50% to 100%.

20. The method of claim 17, wherein the drying is performed under constant temperature and constant humidity conditions.
